(19) United States
(12) Patent Application Publication
(10) Pub. No.: US 2014/0280239 A1
(43) Pub. Date: Sep. 18, 2014

(54) SIMILARITY DETERMINATION BETWEEN ANONYMIZED DATA ITEMS

(71) Applicant: SAS Institute Inc., Cary, NC (US)

(72) Inventors: James Edward Georges, Irvine, CA (US); David Lee Kuhn, Cave Creek, AZ (US); Edward Lew Rowe, Apex, NC (US); John Michael Kichak, Raleigh, NC (US); Karcsi Fritz Lehr, Cary, NC (US)

(73) Assignee: SAS Institute Inc., Cary, NC (US)

(21) Appl. No.: 13/962,103

(22) Filed: Aug. 8, 2013

Related U.S. Application Data
(60) Provisional application No. 61/790,955, filed on Mar. 15, 2013.

(51) Int. Cl. G06F 17/30

(52) U.S. Cl. CPC G06F 17/30663
USPC 707/749

(57) ABSTRACT

A method of determining a similarity between records in a data set is provided. Data organized into a plurality of records is received. First characters associated with a field and a first record of the plurality of records are selected. The selected first characters are subdivided into a first sliding series of a defined number of characters. Second characters associated with the field and a second record of the plurality of records are selected. The selected second characters are subdivided into a second sliding series of the defined number of characters. A similarity score between the first sliding series and the second sliding series is calculated. Whether or not the first sliding series and the second sliding series are similar is determined based on the calculated similarity score.

### CROSS-REFERENCE TO RELATED APPLICATIONS

The present application claims priority to U.S. Provisional Patent Application No. 61/790,955 filed Mar. 15, 2013, the entire contents of which are hereby incorporated by reference.

### BACKGROUND

Identity resolution, the process of coordinating disparate data records referring to the same entity, such as ‘Robert’, ‘Robby’, ‘Bob’, and ‘Bobby’, which may all refer to the same individual, may require fuzzy linking. Fuzzy linking between multiple data records is especially important in fraud detection activities in which the data to be analyzed includes governmental or financial institution data related to individuals that must be protected. Thus, the personally identifiable information in the data may require anonymization to maintain the privacy and the security of the data according to legal and ethical requirements.

### SUMMARY

In an example embodiment, a method of determining a similarity between records in a data set is provided. Data organized into a plurality of records is received. First characters associated with a field and a first record of the plurality of records are selected. The selected first characters are subdivided into a first sliding series of a defined number of characters. Second characters associated with the field and a second record of the plurality of records are selected. The selected second characters are subdivided into a second sliding series of the defined number of characters. A similarity score between the first sliding series and the second sliding series is calculated. Whether or not the first sliding series and the second sliding series are similar is determined based on the calculated similarity score.

In another example embodiment, a computer-readable medium is provided having stored thereon computer-readable instructions that when executed by a computing device, cause the computing device to perform the method of determining a similarity between records in a data set.

In yet another example embodiment, a system is provided. The system includes, but is not limited to, a processor and a computer-readable medium operably coupled to the processor. The computer-readable medium has instructions stored thereon that, when executed by the processor, cause the system to perform the method of determining a similarity between records in a data set.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of an anonymizing data processing system in accordance with an illustrative embodiment.

FIG. 2 depicts a block diagram of an anonymizing device of the anonymizing data processing system of FIG. 1 in accordance with an illustrative embodiment.

FIG. 3 depicts a block diagram of an anonymized data processing device of the anonymizing data processing system of FIG. 1 in accordance with an illustrative embodiment.

FIG. 4 depicts a flow diagram illustrating examples of operations performed by the anonymizing device of FIG. 2 in accordance with an illustrative embodiment.

FIG. 5 depicts a flow diagram illustrating examples of operations performed by the anonymized data processing device of FIG. 3 in accordance with an illustrative embodiment.

FIG. 6 depicts a flow diagram illustrating examples of operations performed by the anonymized data processing device of FIG. 3 in accordance with another illustrative embodiment.

### DETAILED DESCRIPTION

Referring to FIG. 1, a block diagram of an anonymizing data processing system 100 is shown in accordance with an illustrative embodiment. In an illustrative embodiment, anonymizing data processing system 100 may include a data anonymizing system 104, an anonymized data processing system 106, and a network 108. Data anonymizing system 104 anonymizes data. As used herein, the data may include any type of content represented in any computer-readable format such as binary, alphanumeric, numeric, string, markup language, etc. The content may include textual information, graphical information, image information, audio information, numeric information, etc. that further may be encoded using various encoding techniques as understood by a person of skill in the art. Anonymized data processing device 106 processes the anonymized data, for example, to identify similar records in the data.

The components of anonymizing data processing system 100 may be included in a single computing device, may be positioned in a single room or adjacent rooms, in a single facility, and/or may be distributed geographically from one another. Thus, though data anonymizing system 104 and anonymized data processing system 106 may be composed of one or more discrete devices, anonymizing system 104 and anonymized data processing system 106 may be integrated into a single device.

Network 108 may include one or more networks of the same or different types. Network 108 can be any type of wired and/or wireless public or private network including a cellular network, a local area network, a wide area network such as the Internet, etc. Network 108 further may comprise sub-networks and consist of any number of devices.

Data anonymizing system 104 can include any number and type of computing devices that may be organized into subnets. The computing devices of data anonymizing system 104 send and receive signals through network 108 to/from another of the one or more computing devices of data anonymizing system 104 and/or to/from anonymized data processing system 106. The one or more computing devices of data anonymizing system 104 may include computers of any form factor such as a laptop 110, a desktop 112, a smart phone 114, a personal digital assistant, an integrated messaging device, a tablet computer, etc. The one or more computing devices of data anonymizing system 104 may communicate using various transmission media that may be wired and/or wireless as understood by those skilled in the art.

Anonymized data processing system 106 can include any number and type of computing devices that may be organized into subnets. The computing devices of anonymized data processing system 106 send and receive signals through network 108 to/from another of the one or more computing devices of anonymized data processing system 106 and/or to/from data anonymizing system 104. The one or more computing devices of anonymized data processing system 106 may include computers of any form factor such as a laptop 116, a desktop 118, a smart phone 120, an integrated messaging device, a personal digital assistant, a tablet computer, etc. The one or more computing devices of anonymized data processing system 106 may communicate using various transmission media that may be wired and/or wireless as understood by those skilled in the art.

Referring to FIG. 2, a block diagram of an anonymizing device 200 of data anonymizing system 104 is shown in accordance with an illustrative embodiment. Anonymizing device 200 is an example computing device of data anonymizing system 104. Anonymizing device 200 may include an input interface 204, an output interface 206, a communication interface 208, a computer-readable medium 210, a processor 212, a keyboard 214, a mouse 216, a display 218, a speaker 220, a printer 222, a data anonymizing application 224, and database 226. Fewer, different, and additional components may be incorporated into anonymizing device 200.

Input interface 204 provides an interface for receiving information from the user for entry into anonymizing device 200 as understood by those skilled in the art. Input interface 204 may interface with various input technologies including, but not limited to, keyboard 214, mouse 216, display 218, a track ball, a keypad, one or more buttons, etc. to allow the user to enter information into anonymizing device 200 or to make selections in a user interface displayed on display 218. Display 218 may be a thin film transistor display, a light emitting diode display, a liquid crystal display, or any of a variety of different display types as understood by those skilled in the art. Keyboard 214 may be any of a variety of keyboard types as understood by those skilled in the art. Mouse 216 may be any of a variety of mouse type devices as understood by those skilled in the art. The same interface may support both input interface 204 and output interface 206. For example, a display comprising a touch screen both allows user input and presents output to the user. Anonymizing device 200 may have one or more input interfaces that use the same or a different input interface technology. Keyboard 214, mouse 216, display 218, etc. further may be accessible by anonymizing device 200 through communication interface 208.

Output interface 206 provides an interface for outputting information for review by a user of anonymizing device 200. For example, output interface 206 may interface with various output technologies including, but not limited to, display 218, speaker 220, printer 222, etc. Speaker 220 may be any of a variety of speaker types as understood by those skilled in the art. Printer 222 may be any of a variety of printer types as understood by those skilled in the art. Anonymizing device 200 may have one or more output interfaces that use the same or a different interface technology. Speaker 220, printer 222, etc. further may be accessible by anonymizing device 200 through communication interface 208.

Communication interface 208 provides an interface for receiving and transmitting data between devices using various protocols, transmission technologies, and media as understood by those skilled in the art. Communication interface 208 may support communication using various transmission media that may be wired and/or wireless. Anonymizing device 200 may have one or more communication interfaces that use the same or a different communication interface technology. Data and messages may be transferred between anonymizing device 200 and anonymized data processing system 106 using communication interface 208.

Computer-readable medium 210 is an electronic holding place or storage for information so the information can be accessed by processor 212 as understood by those skilled in the art. Computer-readable medium 210 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. Anonymizing device 200 may have one or more computer-readable media that use the same or a different memory media technology. Anonymizing device 200 also may have one or more drives that support the loading of a memory media such as a CD or DVD.

Processor 212 executes instructions as understood by those skilled in the art. The instructions may be carried out by a special purpose computer, logic circuits, or hardware circuits. Processor 212 may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor 212 executes an instruction, meaning it performs/controls the operations called for by that instruction. Processor 212 operably couples with input interface 204, with output interface 206, with communication interface 208, and with computer-readable medium 210 to receive, to send, and to process information. Processor 212 may retrieve a set of instructions from a permanent memory device and copy the instructions in an executable form to a temporary memory device that is generally some form of RAM. Anonymizing device 200 may include a plurality of processors that use the same or a different processing technology.

Data anonymizing application 224 performs operations associated with anonymizing data. Some or all of the operations described herein may be embodied in data anonymizing application 224. The operations may be implemented using hardware, firmware, software, or any combination of these methods. Referring to the example embodiment of FIG. 2, data anonymizing application 224 is implemented in software (comprised of computer-readable and/or computer-executable instructions) stored in computer-readable medium 210 and accessible by processor 212 for execution of the instructions that embody the operations of data anonymizing application 224. Data anonymizing application 224 may be written using one or more programming languages, assembly languages, scripting languages, etc.

Data anonymizing application 224 may be implemented as a Web application. For example, data anonymizing application 224 may be configured to receive hypertext transport protocol (HTTP) responses from other computing devices, such as those associated with anonymized data processing device 106, and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol. The file accessed may be a simple text file, an image file, an audio file, a video file, an executable, a common gateway interface application, a Java applet, an extensible markup language (XML) file, or any other type of file supported by HTTP.

Anonymizing device 200 may include database 226 stored on computer-readable medium 210 or can access database 226 either through a direct connection or through network 108 using communication interface 208. Database 226 is a data repository for anonymizing data processing system 100. Database 226 may include a plurality of databases that may be organized into multiple database tiers to improve data management and access. Database 226 may utilize various database technologies and a variety of formats as known to those skilled in the art including a file system, a relational database, a system of tables, a structured query language database, etc. Database 226 may be implemented as a single database or as multiple databases stored in different storage locations distributed over network 108 and using the same or different formats.

Referring to FIG. 3, a block diagram of an anonymized data processing device 300 of anonymized data processing system 106 is shown in accordance with an example embodiment. Anonymized data processing device 300 is an example computing device of anonymized data processing system 106. Anonymized data processing device 300 may include a second input interface 304, a second output interface 306, a second communication interface 308, a second computer-readable medium 310, a second processor 312, a second keyboard 314, a second mouse 316, a second display 318, a second speaker 320, a second printer 322, a data processing application 324, and a second database 326. Fewer, different, and additional components may be incorporated into anonymized data processing device 300.

Second input interface 304 provides the same or similar functionality as that described with reference to input interface 204 of anonymizing device 200 though referring to anonymized data processing device 300 instead of anonymizing device 200. Second output interface 306 provides the same or similar functionality as that described with reference to output interface 206 of anonymizing device 200 though referring to anonymized data processing device 300 instead of anonymizing device 200. Second communication interface 308 provides the same or similar functionality as that described with reference to communication interface 208 of anonymizing device 200 though referring to anonymized data processing device 300 instead of anonymizing device 200. Data and messages may be transferred between anonymized data processing device 300 and data anonymizing system 104 using second communication interface 308. Second computer-readable medium 310 provides the same or similar functionality as that described with reference to computer-readable medium 210 of anonymizing device 200 though referring to anonymized data processing device 300 instead of anonymizing device 200. Second processor 312 provides the same or similar functionality as that described with reference to processor 212 of anonymizing device 200 though referring to anonymized data processing device 300 instead of anonymizing device 200. Second keyboard 314 provides the same or similar functionality as that described with reference to keyboard 214 of anonymizing device 200 though referring to anonymized data processing device 300 instead of anonymizing device 200. Second mouse 316 provides the same or similar functionality as that described with reference to mouse 216 of anonymizing device 200 though referring to anonymized data processing device 300 instead of anonymizing device 200. Second display 318 provides the same or similar functionality as that described with reference to display 218 of anonymizing device 200 though referring to anonymized data processing device 300 instead of anonymizing device 200. Second speaker 320 provides the same or similar functionality as that described with reference to speaker 220 of anonymizing device 200 though referring to anonymized data processing device 300 instead of anonymizing device 200. Second printer 322 provides the same or similar functionality as that described with reference to printer 222 of anonymizing device 200 though referring to anonymized data processing device 300 instead of anonymizing device 200.

Data processing application 324 performs operations associated with processing data anonymized by anonymizing device 200. Some or all of the operations described herein may be embodied in data processing application 324. The operations may be implemented using hardware, firmware, software, or any combination of these methods. Referring to the example embodiment of FIG. 3, data processing application 324 is implemented in software (comprised of computer-readable and/or computer-executable instructions) stored in second computer-readable medium 310 and accessible by second processor 312 for execution of the instructions that embody the operations of data processing application 324. Data processing application 324 may be written using one or more programming languages, assembly languages, scripting languages, etc.

Data processing application 324 may be implemented as a Web application. For example, data processing application 324 may be configured to receive HTTP responses from other computing devices, such as those associated with data anonymizing system 104, and to send HTTP requests. The HTTP responses may include web pages such as HTML documents and linked objects generated in response to the HTTP requests. Each web page may be identified by a URL that includes the location or address of the computing device that contains the resource to be accessed in addition to the location of the resource on that computing device. The type of file or resource depends on the Internet application protocol. The file accessed may be a simple text file, an image file, an audio file, a video file, an executable, a common gateway interface application, a Java applet, an XML file, or any other type of file supported by HTTP.

Anonymized data processing device 300 may include second database 326 stored on second computer-readable medium 310 or can access second database 326 either through a direct connection or through network 108 using second communication interface 308. Second database 326 is another data repository for anonymizing data processing system 100. For example, the data processed using data processing application 324 may be stored in second database 326. Second database 326 may include a plurality of databases that may be organized into multiple database tiers to improve data management and access. Second database 326 may utilize various database technologies and a variety of formats as known to those skilled in the art including a file system, a relational database, a system of tables, a structured query language database, etc. Second database 326 may be implemented as a single database or as multiple databases stored in different storage locations distributed over network 108 and using the same or different formats.

Second database 326 and database 226 may be a single integrated database stored on computer-readable medium 210 and/or on second computer-readable medium 310 or on another computing device accessible through network 108 using second communication interface 308. Thus, data processing application 324 and data anonymizing application 224 may save or store data to second database 326 and/or database 226 and access or retrieve data from second database 326 and/or database 226.

Data processing application 324 and data anonymizing application 224 may be the same or different applications or part of an integrated, distributed application supporting some or all of the same or additional types of functionality as described herein. As an example, the functionality provided by data processing application 324 and data anonymizing application 224 may be provided as part of the DataFlux Engine offered by SAS Institute Inc. Various levels of integration between the components of anonymizing data processing system 100 may be implemented without limitation as understood by a person of skill in the art. For example, all of the functionality described referring to anonymizing data processing system 100 may be implemented in a single application that may be executed at a single computing device.

Referring to FIG. 4, example operations associated with data anonymizing application 224 are described. Additional, fewer, or different operations may be performed depending on the embodiment. The order of presentation of the operations of FIG. 4 is not intended to be limiting. A user can interact with one or more user interface windows presented to the user in display 218 under control of anonymizing application 224 independently or through a browser application in an order selectable by the user. As further understood by a person of skill in the art, various operations may be performed in parallel, for example, using threading. Although some of the operational flows are presented in sequence, the various operations may be performed in various repetitions, concurrently, and/or in other orders than those that are illustrated.

For example, a user may execute anonymizing application 224, which causes presentation of a first user interface window, which may include a plurality of menus and selectors such as drop down menus, buttons, text boxes, hyperlinks, etc. associated with anonymizing application 224 as understood by a person of skill in the art. Anonymizing application 224 controls the presentation of one or more additional user interface windows that further may include menus and selectors such as drop down menus, buttons, text boxes, hyperlinks, additional windows, etc. based on user selections received by anonymizing application 224. As understood by a person of skill in the art, the user interface windows are presented on display 218 under control of the computer-readable and/or computer-executable instructions of anonymizing application 224 executed by processor 212 of anonymizing device 200. As the user interacts with the user interface windows presented under control of anonymizing application 224, different user interface windows may be presented to provide the user with various controls from which the user may make selections or enter values associated with various application controls. In response, as understood by a person of skill in the art, anonymizing application 224 receives an indicator associated with an interaction by the user with a user interface window. Based on the received indicator, anonymizing application 224 performs one or more additional operations.

In an operation 400, data is received. As an example, the data may be selected by a user using a user interface window and received by anonymizing application 224. For example, the data may be stored in computer-readable medium 210 as a file and/or in database 226 and received by retrieving the data from the appropriate memory location as understood by a person of skill in the art. In an illustrative embodiment, the data is organized as a plurality of fields for a plurality of records. Merely for illustration, the data may include data for banking customers including balances, transaction counts, credit scores, etc. An example dataset may include from a few to hundreds of fields or more and from a few to tens of thousands of records or more without limitation.

In an operation 401, a number of characters in a sliding series, N, is received after interaction by the user with a user interface window. For example, a numerical value is received that indicates a user selection of the value to be used for N. As an example, the value may be entered by the user using mouse 216, keyboard 214, display 218, etc. In an illustrative embodiment, instead of receiving a user selection through the presented user interface window, a default value for N may be stored in computer-readable medium 210 and received by retrieving the value from the appropriate memory location as understood by a person of skill in the art. N further may be defined as a function of the field in the dataset. For example, for a field that typically includes a large number of characters (i.e., >20 characters), N may be larger than for a field that typically includes a smaller number of characters (i.e., <20 characters).

A larger N may be more sensitive to errors in short strings possibly resulting in a higher rate of false negatives. Strings may not be identified as similar when the strings may be very similar. For illustration, when a five letter word with a single error in the third position is evaluated and N=3 a zero similarity score results. Conversely, a smaller N may be less sensitive to errors in longer strings possibly resulting in a higher rate of false positives. With some knowledge of the type of strings present in the dataset, an appropriate value of N may be defined for each field. In a dataset of drug names, a larger N may work well because the strings typically are long and repeat the same roots. For general application, N=3 may be used. Merely for illustration, N may be between 2 and 10.

While a greater average word length in the records to be compared allows for selection of a larger N (and less expensive comparisons), the number of dimensions generated may be considered also. In practice, database retrieval of possibly matching records is improved when blocking by one or more dimensions is utilized possibly by instituting a table for each block. While a greater N resulting in a greater number of dimensions and a larger number of blocks can improve blocking resolution, the number of blocking tables can quickly increase to an unwieldy total.

In an operation 402, characters are selected from a first field of a first record of the received data. The first field may include any number of characters that may include alphanumeric or non-alphanumeric values such as various symbols and spaces. For illustration, the fields may include a first name, a middle initial, a last name, a date of birth, a social security number, a street address, a city, a state, a zip code, a phone number, an email address, a driver's license number, an employer, a salary, a bank name, a bank account number, a bank account balance, etc. In an illustrative embodiment, the selected characters may be combined from a plurality of fields. For example, characters from a first name field, a middle initial field, and a last name field may be combined to form the selected characters. In an illustrative embodiment, non-alphanumeric values may be removed from the field values such that the selected characters do not include non-alphanumeric values. For example, spaces may be removed from a name field.

In an operation 404, the selected characters are subdivided into a sliding series of characters having length N. For illustration, if the selected characters are RUSSELL and N=3, the sliding series of characters is RUS USS SSE SEL ELL. If the selected characters are RUSSELL and N=4, the sliding series of characters is RUSS USSE SSEL SELL. As another example, if the selected characters are RUSSELL WILLIAM ROWE from three fields and N=3, the sliding series of characters is RUS USS SSE SEL ELL for the first field, WIL ILL LLI LIA IAM for the second field, and ROW OWE for the third field. As still another example, if the selected characters are WILLIAM JUDSON ROWE from the fields and N=3, the sliding series of characters is WIL ILL LLI LIA IAM for the first field, JUD UDS DSO SON for the second field, and ROW OWE for the third field.

In an operation 406, the subdivided characters are encoded. For example, the subdivided characters may be encoded using an arbitrary substitution cipher, such as a Caesar cipher. Any encoding method that preserves the innate structure of the characters can be used.

In an operation 408, the encoded characters are sorted. For example, the encoded characters may be sorted alphabetically and/or numerically in descending or ascending order.

In an operation 410, the sorted characters are stored, for example, to computer-readable medium 208/database 226. As an example, the three subdivided fields RUS USS SSE SEL ELL WIL ILL LLI LIA IAM ROW OWE may be combined, encoded, and sorted as CGY CWW ECW FEX JLL LLX LXW PFE PJL WCG WWC XWW. Using the same encoding method, WIL ILL LLI LIA IAM JUD UDS DSO SON ROW OWE may be combined, encoded, and sorted as CGY CWW ECW FEX IJU JUL LFH PFE ULF WCG WWC.

In an operation 412, a determination is made concerning whether or not another field or record is to be processed from the received data. For example, for each record in the received data some or all of the fields are anonymized by repeating operations 402 to 412. If there is an additional field or record to anonymize, processing continues in an operation 414 to select the next field from the same record or from another record, and processing continues in operation 402. If there are no additional fields or records to anonymize, processing stops in an operation 416. The user may select the fields to be anonymized, for example, using a user interface window.

Referring to FIG. 5, example operations associated with data processing application 324 are described in accordance with an illustrative embodiment. Additional, fewer, or different operations may be performed depending on the embodiment. The order of presentation of the operations of FIG. 5 is not intended to be limiting. A user can interact with one or more user interface windows presented to the user in display 318 under control of data processing application 324 as explained previously with reference to FIG. 4 and anonymizing application 224.

In an operation 500, anonymized data is received. As an example, the data may be selected by a user using a user interface window and received by data processing application 324. The data may be stored in computer-readable medium 210, database 226, second computer-readable medium 310, and/or second database 326 and received by retrieving the anonymized data from the appropriate memory location as understood by a person of skill in the art. The anonymized data is organized as a plurality of fields for the plurality of records as originally defined in the data received in operation 400 of FIG. 4. Though some of the fields of the data received in operation 400 of FIG. 4 may be combined to form a single field in the anonymized data, the records remain associated with the same record (i.e., subject) as the data received in operation 400 of FIG. 4.

In an operation 502, first characters are selected from a first field of a first record of the received anonymized data. In an operation 504, second characters are selected from the first field of a second record of the received anonymized data.

In an operation 506, a similarity score value is calculated. For example, the selected first and second characters may be treated as a vector of dimension CN where C is the number of characters in the language set and N is the number of characters in the sliding series received in operation 401. For alphabetic characters in the roman alphabet, C=26. If N=3, a dimension of 26³ or 17,576 results for the vectors.

For illustration, the similarity score value may be calculated by applying the law of cosines to the character vectors formed for the selected first and second characters. The angle between the two character vectors represents the similarity between the selected first and second characters. If the cosine is zero, the two character vectors are orthogonal indicating there is no similarity determined between the selected first and second characters. If the cosine is one, the two character vectors are parallel indicating the selected first and second characters are equivalent, and the result is considered an exact match. Similarity score values between zero and one may result using the law of cosines.

Continuing with the examples above with the first characters as CGY CWW ECW FEX JLL LLX LXW PFE PJL WCG WWC XWW and the second characters as CGY CWW ECW FEX IJU JUL LFH PFE ULF WCG WWC, 16 of the 17,576 dimensions (unique three-character strings) are represented. Shortening the vectors from the 17,576 dimensions to the 16 relevant dimensions results in a first character vector V₁: (1, 1, 1, 1, 0, 1, 0, 0, 1, 1, 1, 1, 0, 1, 1, 1), and a second character vector V₂: (1, 1, 1, 1, 1, 0, 1, 1, 0, 0, 1, 0, 1, 1, 1, 0) based on the unique three-character strings sorted in alphabetic order as (CGY, CWW, ECW, FEX, IJU, JLL, JUL, LFH, LLX, LXW, PFE, PJL, ULF, WCG, WWC, XWW). Based on the law of cosines, the similarity score value may be calculated as

$$S = cos ( θ ) = \frac{{V}_{1} \cdot {V}_{2}}{‖ {V}_{1} ‖ ‖ {V}_{2} ‖}$$

In the case where neither character vector has a repeated use of a unique three-character string, the calculation of the similarity score S simplifies to

$$S = cos ( θ ) = \frac{{N}_{c}}{\sqrt{{N}_{1}} * \sqrt{{N}_{2}}}$$

where N_{c} is the number of three-character strings in common between first character vector V₁ and second character vector V₂, N₁ is the number of three-character strings in first character vector V₁, and N₂ is the number of three-character strings in first character vector V₂. In the example above, S=7/(\sqrt{12}*\sqrt{11})=0.60927.

In an operation 508, a determination is made concerning whether or not the two records are similar. For example, the user may define a threshold T as an input or as a default value as understood by a person of skill in the art. The threshold may be defined based on the field. In the illustrative embodiment, the law of cosines is used to calculate the similarity score. As discussed previously, a similarity score of one implies parallel vectors and an included angle of zero degrees, while a similarity score of zero implies orthogonal vectors and an included angle of 90 degrees. From a geometric perspective, an included angle less than 45 degrees implies two vectors are closer to parallel than to orthogonal. For illustration, using 45 degrees as a threshold included angle value, T=cos(45)=˜0.707. As another illustration, T may be defined as 0.5. Of course, other values may be used.

If S≧T, the two character vectors may be determined to be similar. If S<T, the two character vectors may be determined not to be similar. Of course, if S>T, the two character vectors may be determined to be similar, and if S≦T, the two character vectors may be determined not to be similar. In an illustrative embodiment, a determination that two character vectors representing the field of the first record and of the second record is a determination that the records are similar.

In an operation 510, an indicator associated with records determined to be similar is output. For example, a first record number associated with the first record and a second record number associated with the second record are stored, for example, to computer-readable medium 208/database 226. Of course, the indicator may be output using second display 318, second speaker 320, and/or second printer 322.

In an operation 512, a determination is made concerning whether or not the anonymized data includes another record to be compared to the first record. If the dataset includes another record, the next record is selected in an operation 514, and the processing of operations 504 to 512 is repeated with the selected next record as the second record.

If the dataset does not include another record, in an operation 516, a determination is made concerning whether or not the first record includes another field to be compared between records. If the dataset includes another field to be compared, the next field is selected in an operation 518, and the processing of operations 502 to 512 is repeated with the selected next field of the first record and the selected next field of the second record.

If the dataset does not include another field, in an operation 520, a determination is made concerning whether or not another pair of records is to be compared. If there is another pair of records to be compared, in an operation 522, the next record is selected as the first record and the subsequent record to the next record is selected as the second record, and the processing of operations 502 to 520 is repeated for the first field of the selected next pair of records. If there is not another pair of records to be compared, in an operation 524, processing of the anonymized data stops.

There are numerous methods of sequencing through the anonymized data to identify similar records as understood by a person of skill in the art. Referring to FIG. 6, example operations associated with data processing application 324 are described in accordance with another illustrative embodiment. Additional, fewer, or different operations may be performed depending on the embodiment. The order of presentation of the operations of FIG. 6 is not intended to be limiting. A user can interact with one or more user interface windows presented to the user in display 318 under control of data processing application 324 as explained previously with reference to FIG. 4 and anonymizing application 224.

In an operation 600, anonymized data is received, for example, as described with reference to operation 500. In an operation 602, first characters are selected from a first field of a first record of the received anonymized data, for example, as described with reference to operation 502. In an operation 604, second characters are selected from a first field of a second record of the received anonymized data, for example, as described with reference to operation 504. In an operation 606, a similarity score is calculated, for example, as described with reference to operation 506.

In an operation 608, a determination is made concerning whether or not another field is to be compared between the first record and the second record. If the dataset includes another field to be compared between the first record and the second record, the next field is selected in an operation 612, and the processing of operations 602 to 608 is repeated with the selected next field of the first record and the selected next field of the second record.

If the dataset does not include another field, in an operation 610, a determination is made concerning whether or not the two records are similar. As discussed previously with reference to operation 508, the user may define a threshold T used to determine if fields are similar based on the calculated similarity score. In an illustrative embodiment, a determination that one or more of the fields of the first record and the second record are similar is a determination that the records are similar. For example, the user may define a number of similar fields needed to indicate that the records are similar as an input N_{M} or as a default value as understood by a person of skill in the art.

In an operation 614, an indicator associated with records determined to be similar is output, for example, as described with reference to operation 502. In an operation 512, a determination is made concerning whether or not the anonymized data includes another record to be compared to the first record. If the dataset includes another record to be compared to the first record, the next record is selected in an operation 618, and the processing of operations 604 to 616 is repeated with the selected next record as the second record.

If the dataset does not include another record to be compared to the first record, in an operation 620, a determination is made concerning whether or not another pair of records is to be compared. If there is another pair of records to be compared, in an operation 622, the next record is selected as the first record and the subsequent record to the next record is selected as the second record, and the processing of operations 602 to 620 is repeated for the first field of the selected next pair of records. If there is not another pair of records to be compared, in an operation 624, processing of the anonymized data stops.

In an illustrative embodiment, a data owner may execute data anonymiznig application 224 to create the anonymized data that is sent to a data processor. The anonymized data preserves the innate structure of the language elements that comprise the original records, but is agnostic to the encoding used. For example, the anonymized data is agnostic to a key chosen for a substitution cipher used to encode the data. Sorting in operation 408 further reduces the ability to reverse engineer the encoding process and counteract the security measures. A similarity score can be calculated between records without processing the original data.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated. It is intended that the scope of the disclosed subject matter be defined by the claims appended hereto and their equivalents.

What is claimed is:

1. A computer-readable medium having stored thereon computer-readable instructions that when executed by a computing device cause the computing device to:
(a) receive data organized into a plurality of records;
(b) select first characters associated with a field and a first record of the plurality of records;
(c) subdivide the selected first characters into a first sliding series of a defined number of characters;
(d) select second characters associated with the field and a second record of the plurality of records;
(e) subdivide the selected second characters into a second sliding series of the defined number of characters;
(f) calculate a similarity score between the first sliding series and the second sliding series; and
(g) determine whether the first sliding series and the second sliding series are similar based on the calculated similarity score.

2. The computer-readable medium of claim 1, wherein the computer-readable instructions further cause the computing device to repeat (d)-(e) for the field with each additional record of the plurality of records as the second record.

3. The computer-readable medium of claim 2, wherein the computer-readable instructions further cause the computing device to repeat (f)-(g) for the field with each additional record of the plurality of records as the second record.

4. The computer-readable medium of claim 3, wherein the computer-readable instructions further cause the computing device to repeat (f)-(g) for the field with each additional record of the plurality of records as the first record.

5. The computer-readable medium of claim 1, wherein the data is further organized into a plurality of fields, and the computer-readable instructions further cause the computing device to repeat (b)-(g) for a second field of the plurality of fields.

6. The computer-readable medium of claim 5, wherein the defined number of characters for the field is different than the defined number of characters for the second field.

7. The computer-readable medium of claim 1, wherein the defined number of characters is defined based on a characteristic of a datum associated with the field.

8. The computer-readable medium of claim 1, wherein the computer-readable instructions further cause the computing device to output at least a portion of records determined to be similar.

9. The computer-readable medium of claim 1, wherein the computer-readable instructions further cause the computing device to encode the selected first characters and to encode the selected second characters before (f).

10. The computer-readable medium of claim 9, wherein the selected first characters and the selected second characters are encoded using a substitution cipher algorithm.

11. The computer-readable medium of claim 9, wherein the computer-readable instructions further cause the computing device to encode the selected first characters before (c) and to encode the selected second characters before (e).

12. The computer-readable medium of claim 11, wherein the computer-readable instructions further cause the computing device to sort the first sliding series and the second sliding series before (f).

13. The computer-readable medium of claim 1, wherein the computer-readable instructions further cause the computing device to sort the first sliding series and the second sliding series before (f).

14. The computer-readable medium of claim 13, wherein the first sliding series and the second sliding series are sorted alphabetically.

15. The computer-readable medium of claim 1, wherein the first characters include alphanumeric and non-alphanumeric characters.

16. The computer-readable medium of claim 15, wherein the non-alphanumeric characters are removed from the selected first characters before (c).

17. The computer-readable medium of claim 1, wherein the selected first characters are associated with a plurality of fields.

18. The computer-readable medium of claim 1, wherein the similarity score is calculated by converting the first sliding series to a first vector, by converting the second sliding series to a second vector, and by applying the law of cosines to the first vector and the second vector.

19. The computer-readable medium of claim 1, wherein the first sliding series and the second sliding series are determined to be similar based upon the calculated similarity score satisfying a threshold value test.

20. A system comprising:
a processor; and
a computer-readable medium operably coupled to the processor, the computer-readable medium having computer-readable instructions stored thereon that, when executed by the processor, cause the system to
(a) receive data organized into a plurality of records;
(b) select first characters associated with a field and a first record of the plurality of records;
(c) subdivide the selected first characters into a first sliding series of a defined number of characters;
(d) select second characters associated with the field and a second record of the plurality of records;
(e) subdivide the selected second characters into a second sliding series of the defined number of characters;
(f) calculate a similarity score between the first sliding series and the second sliding series; and
(g) determine whether the first sliding series and the second sliding series are similar based on the calculated similarity score.

21. A method of determining a similarity between records in a dataset, the method comprising:
(a) receiving data organized into a plurality of records at a first device;
(b) selecting, by the first device, first characters associated with a field and a first record of the plurality of records;
(c) subdividing, by the first device, the selected first characters into a first sliding series of a defined number of characters;
(d) selecting, by the first device, second characters associated with the field and a second record of the plurality of records;
(e) subdividing, by the first device, the selected second characters into a second sliding series of the defined number of characters;
(f) calculating, by the first device, a similarity score between the first sliding series and the second sliding series; and
(g) determining, by the first device, whether the first sliding series and the second sliding series are similar based on the calculated similarity score.
